(19) United States
(12) Patent Application Publication
(10) Pub. No.: US 2013/0217280 A1
(43) Pub. Date: Aug. 22, 2013

(54) HYDRAULIC SYSTEM FOR AN AMPHIBIAN

(71) Applicant: Gibbs Technologies Limited, (US)

(72) Inventors: Alan Timothy Gibbs, London (GB); Gary Scicluna, Auburn Hills, MI (US); Gerry Klees, Auburn Hills, MI (US)

(73) Assignee: GIBBS TECHNOLOGIES LIMITED, Nuneaton (GB)

(21) Appl. No.: 13/761,831

(22) Filed: Feb. 7, 2013

Related U.S. Application Data
(60) Provisional application No. 61/595,992, filed on Feb. 7, 2012.

(51) Int. Cl. B60F 3/00

(52) U.S. Cl. CPC B60F 3/0015
USPC 440/12.63; 60/325

(57) ABSTRACT

A hydraulic system for an amphibian provided with at least one retractable wheel or track drive, includes a first hydraulic circuit having at least one hydraulic actuator and associated controller for retracting and protracting the at least one wheel or track drive, a second hydraulic control having at least one hydraulic actuator and associated controller for providing hydraulic assist for steering and/or brake functions of the amphibian.

### BACKGROUND OF THE INVENTION

The present invention relates to a hydraulic system for an amphibian and, in particular, to a hydraulic system for an amphibian provided with at least one retractable wheel or track drive and which is capable of planing on water.

It is known in the art for amphibians to have a suspension system designed to allow the road wheels to be retracted above the amphibian waterline for use of the amphibian on water, particularly so as to reduce the hydrodynamic drag of the hull sufficiently to enable the amphibian to plane on water. Conveniently, said suspension may be retracted and protracted hydraulically. Alternatively, an air or gas suspension system may be used. Hydraulic struts may be used as described in the applicant's International patent application, published as WO 01/74612. The mounting of these struts to the vehicle structure may be as described in the applicant's International patent application, published as WO 02/44006.

The applicant has developed a further high speed amphibian having optimised on-land and on-water performance. The amphibian can plane on water, yet has on-road, off-road and utilitarian capability and is operable in two and/or four wheel drive.

As such, the amphibian presents quite unique challenges in terms of the actuation and control systems required to retract and protract each wheel or track drive, as well as other components such as the reversing bucket of a jet drive marine propulsion unit and the extendable suspension uprights for raising the ride height of the amphibian on land. In addition, the usual hydraulic assist of brakes and steering is also required.

In addition, prior art hydraulic systems for known amphibians are open centre type systems. This has the disadvantage that they require continuous flow of fluid and can create excessive heat within the system, diminishing pump life cycle and increasing the hydraulic system component failure rates.

The present invention seeks to address these deficiencies.

### SUMMARY OF THE INVENTION

Accordingly, in a first aspect, the present invention provides a hydraulic system for an amphibian provided with at least one retractable wheel or track drive, the hydraulic system comprising:

a first hydraulic circuit comprising at least one hydraulic actuator and associated controller for retracting and protracting the at least one wheel or track drive; and

a second hydraulic control comprising at least one hydraulic actuator and associated controller for providing hydraulic assist for steering and/or braking functions of the amphibian.

In a further aspect, the present invention provides an amphibian comprising the hydraulic system set forth herein.

### BRIEF DESCRIPTION OF THE DRAWINGS

Preferred embodiments of the present invention will now be described by way of example only with reference to the accompanying drawings, in which:

FIG. 1 is a schematic hydraulic diagram illustrating an amphibian hydraulic system according to a first preferred embodiment of the present invention, without hydraulic redundancy;

FIG. 2 is a schematic control logic diagram for the amphibian hydraulic system of FIG. 1;

FIG. 3 is a schematic hydraulic diagram illustrating an amphibian hydraulic system according to a further preferred embodiment of the present invention, with hydraulic redundancy;

FIG. 4 is a schematic control logic diagram for the amphibian hydraulic system of FIG. 3;

FIG. 5 is a schematic hydraulic diagram illustrating an amphibian hydraulic system according to a further preferred embodiment of the present invention, with automatic hydraulic redundancy; and

FIG. 6 is a schematic control logic diagram for the amphibian hydraulic system of FIG. 5.

### DETAILED DESCRIPTION OF THE PREFERRED EMBODIMENTS

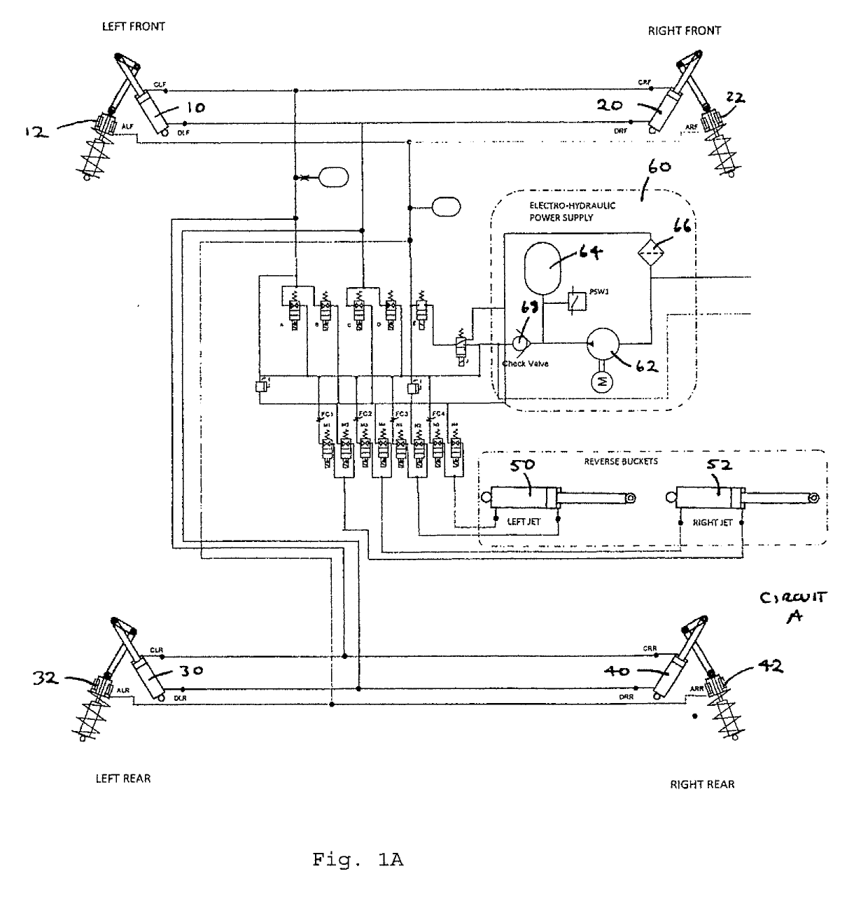

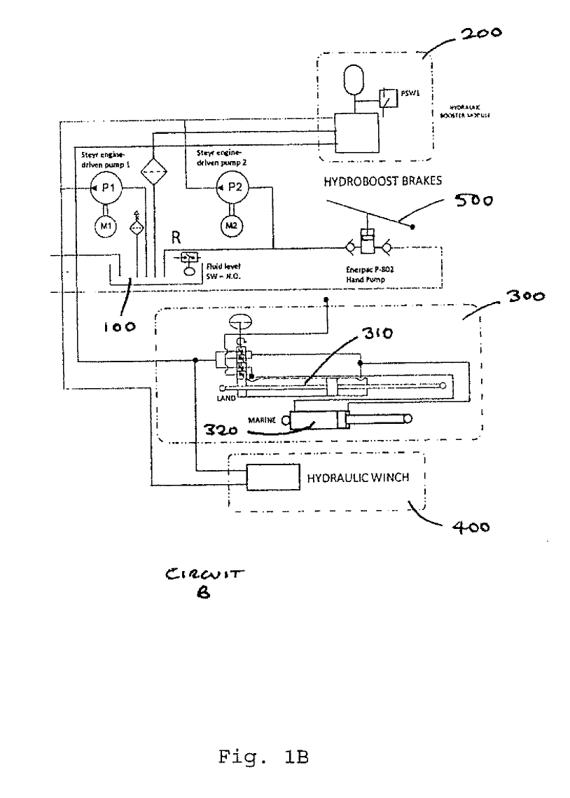

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

Referring first to FIG. 1 there is illustrated a schematic hydraulic system used in an amphibian according to a first preferred embodiment of the present invention. The hydraulic system essentially comprises two hydraulic circuits, circuit A and circuit B. The two hydraulic circuits, circuit A and circuit B, are however linked to provide redundancy capability in the event of component failure, as is described further in detail below.

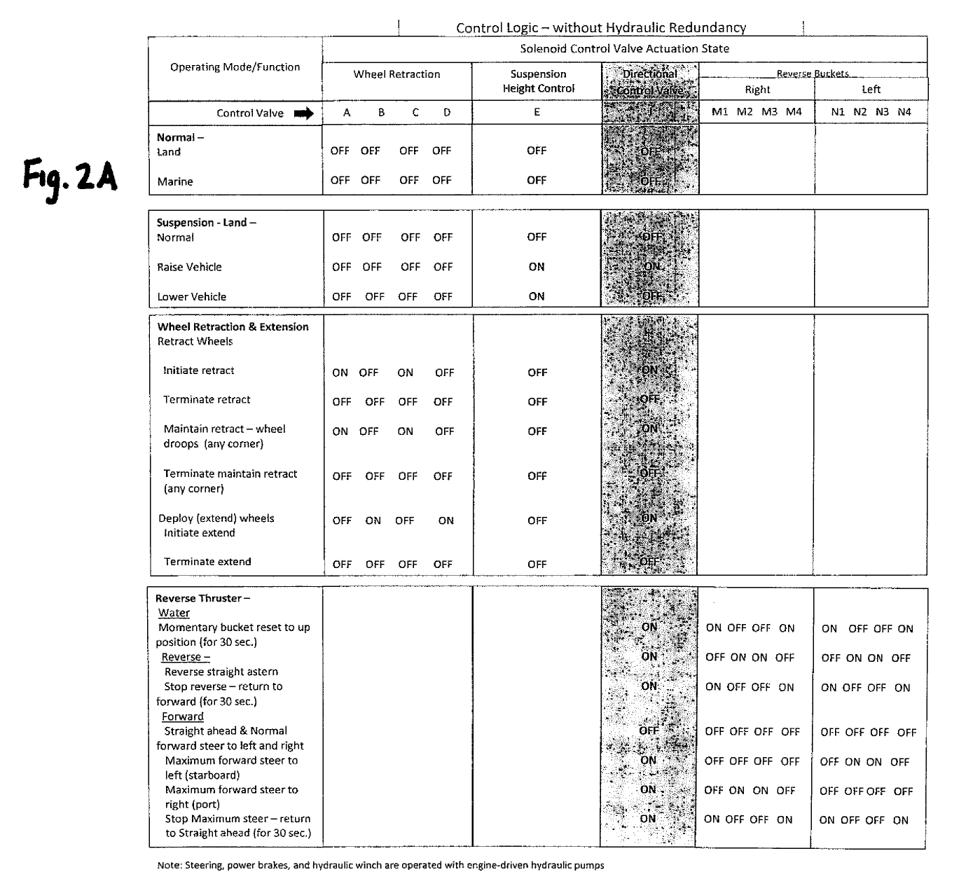

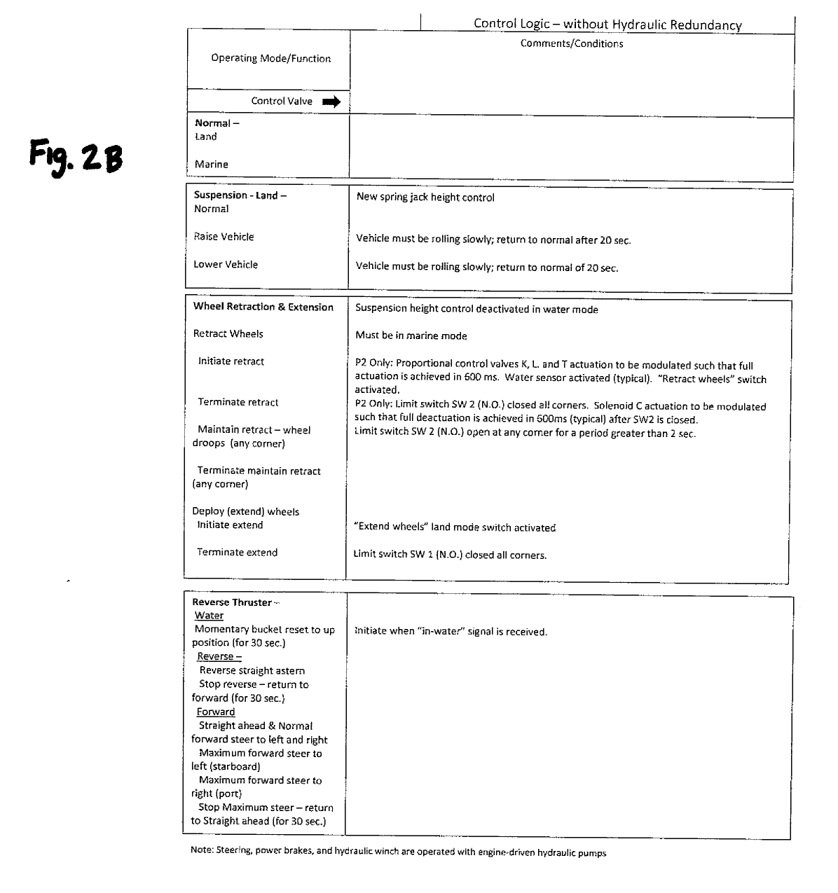

Hydraulic circuit A is used to control protraction and retraction of each wheel or track drive on mode change from land mode to water mode and vice versa via hydraulic actuators 10, 20, 30, 40, to control spring jack operation via hydraulic actuators 12, 22, 32, 42 which serves to extend the ride height of the amphibian at each wheel or track drive location (LEFT FRONT, RIGHT FRONT, LEFT REAR, RIGHT REAR), and to control the reverse bucket operation via hydraulic actuators 50, 52 of two jet drives provided for marine propulsion in water mode. Hydraulic circuit A can require high pressures and high flow rates in use and so is provided with its own dedicated electro-hydraulic power supply 60 optimised for this particular requirement. An electric motor driven hydraulic pump 62 and associated hydraulic circuitry and control valves A, B, C, D, E, J, M1, M2, M3, M4, N1, N2, N3, N4 are provided for operating the circuit components, as will now be described. Hydraulic circuit A is closed-center, that is fluid does not flow until needed. Hydraulic pressure is stored in a hydraulic accumulator 64, which delivers pressurized hydraulic fluid when needed. The hydraulic accumulator 64 is re-pressurized by the electric motor driven hydraulic pump 62 when its pressure drops too low. A hydraulic fluid filter 66 and check valve 68 are also provided. Each of control valves A, B, C, D, E, J, M1, M2, M3, M4, N1, N2, N3, N4 is set to OFF or ON as detailed in the schematic control logic diagram of FIG. 2 to achieve the operating mode/function described.

Hydraulic circuit B is used to provide hydraulically assisted brakes via the hydraulic brake booster module 200 and hydraulically assisted land/marine steering 300 system via hydraulic actuators 310, 320, and also serves to operate ancillaries such as a hydraulic winch 400. Hydraulic circuit B uses a conventional hydraulic assist system, as used in automotive applications. Conventional belt driven hydraulic pumps P1, P2, each driven by respective amphibian engines M1, M2, and associated hydraulic circuitry and control valves are provided for operating the circuit components in a conventional manner. Hydraulic circuit B is open-center, that is hydraulic fluid is flowing always when the amphibian engines M1, M2 are running, and hydraulic fluid pressure is built up by belt driven hydraulic pumps P1, P2 when needed for steering and braking by constricting the hydraulic fluid return flow to the reservoir 100. Conventional hydraulic fluid filters and check valves are also provided.

Hydraulic circuit B can also be seen to comprise a hand pump 500 which serves to provide the ability to provide hydraulic pressure manually to either one or both of the hydraulic circuits A and B in the event of motor of pump failure in either circuit. Generally speaking, this is not required for hydraulic circuit B, which is open-center, as the circuit components e.g. brakes and steering can still be operated manually, albeit requiring greater effort on the part of the driver. Ancillaries such as the hydraulic winch 400 are not critical. In hydraulic circuit A, which is closed-center, the hand pump 500 can be beneficially employed to re-pressurize the hydraulic accumulator 64 in the event of failure of the electric motor driven hydraulic pump 62. This enables the circuit components e.g. wheel retraction/protraction, reversing buckets and spring jack operation to be operated manually, albeit requiring greater effort on the part of the driver.

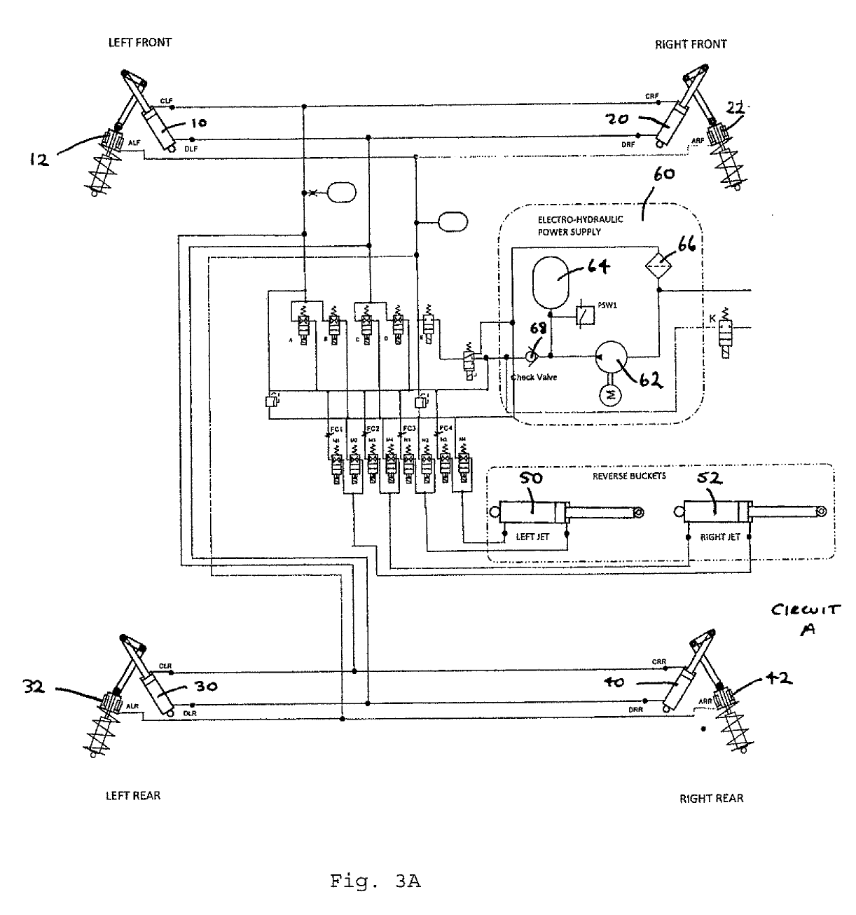

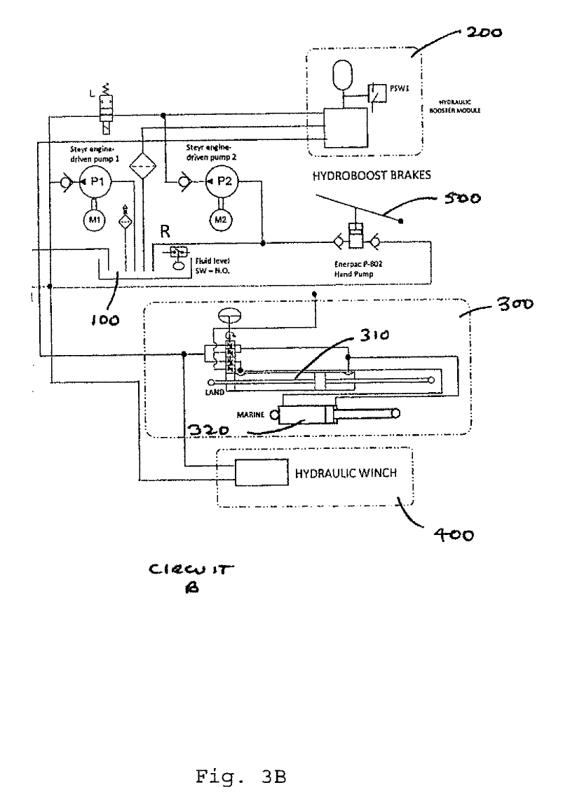

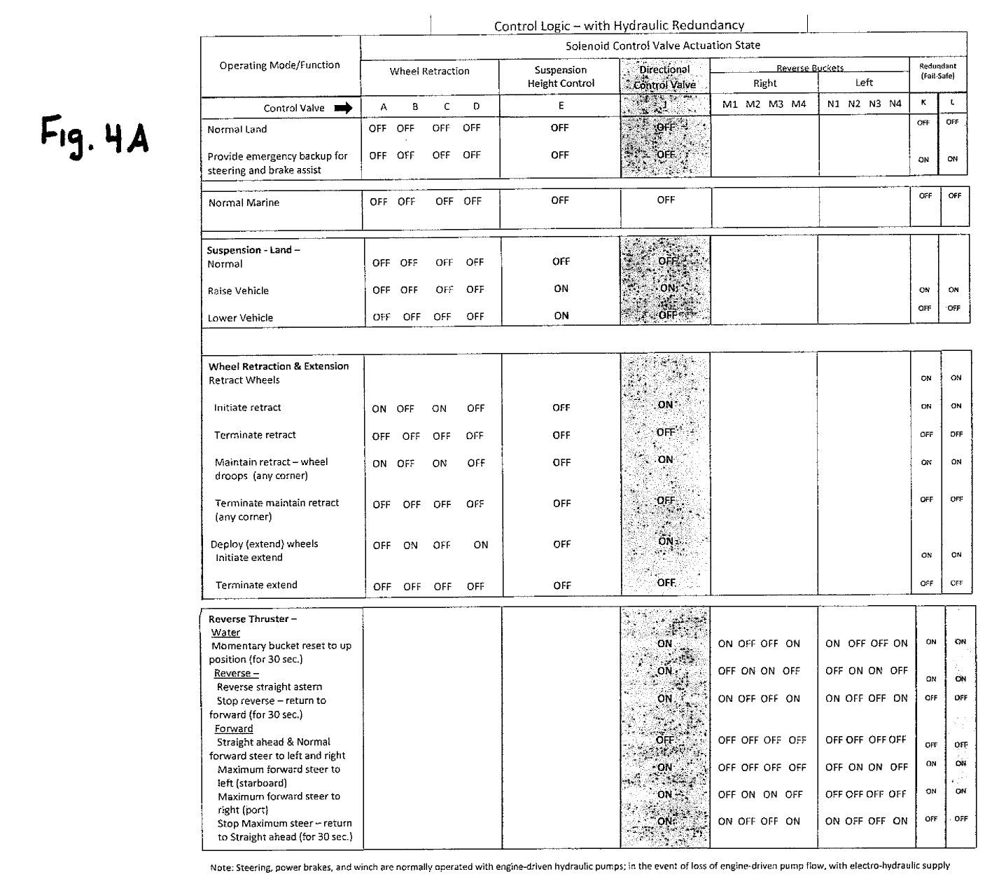

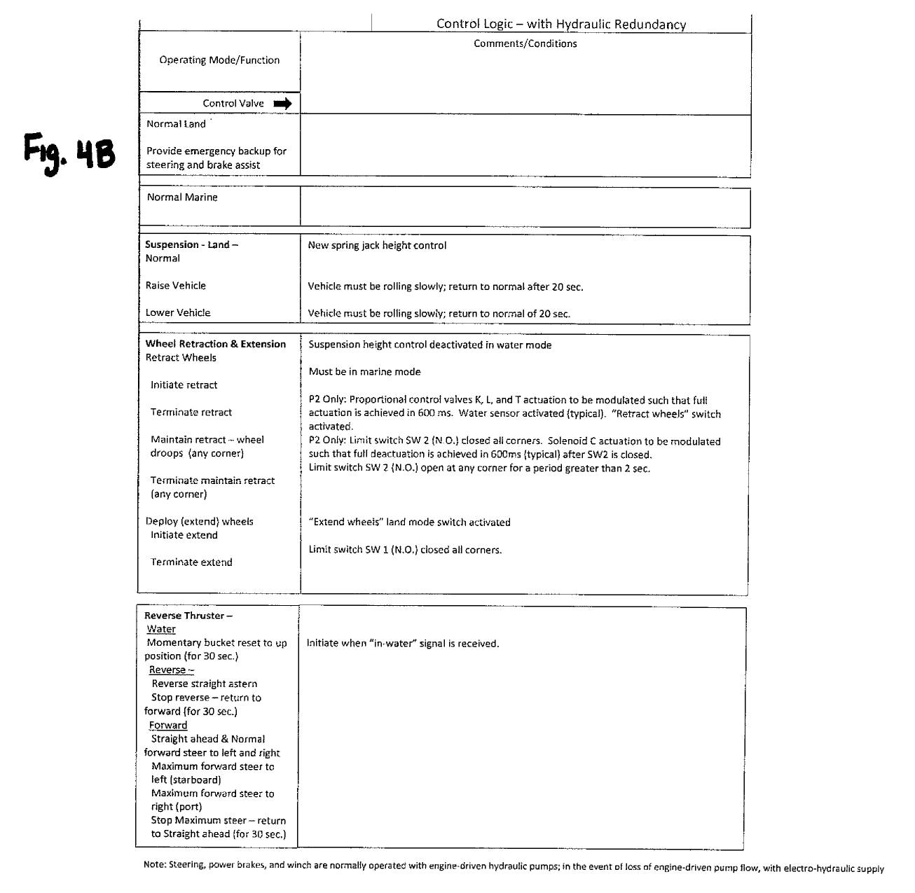

Referring next to FIG. 3, there is illustrated a schematic hydraulic system used in an amphibian according to a further preferred embodiment of the present invention. The corresponding schematic control logic diagram for the amphibian hydraulic system of FIG. 3 is shown in FIG. 4. The hydraulic system of FIGS. 3 and 4 is identical to that described above with reference to FIGS. 1 and 2, save for the addition of two further control valves K and L to provide for hydraulic redundancy in addition to the hand pump 500. In the event of failure of the conventional belt driven hydraulic pumps P1, P2, each driven by respective amphibian engines M1, M2, then additional control valves K and L can open and permit normal functional operation of hydraulic circuit B and its components (hydraulic brake booster module 200, hydraulically assisted land/marine steering 300 system via hydraulic actuators 310, 320, and ancillaries such as a hydraulic winch 400) by way of use of the electric motor driven hydraulic pump 62.

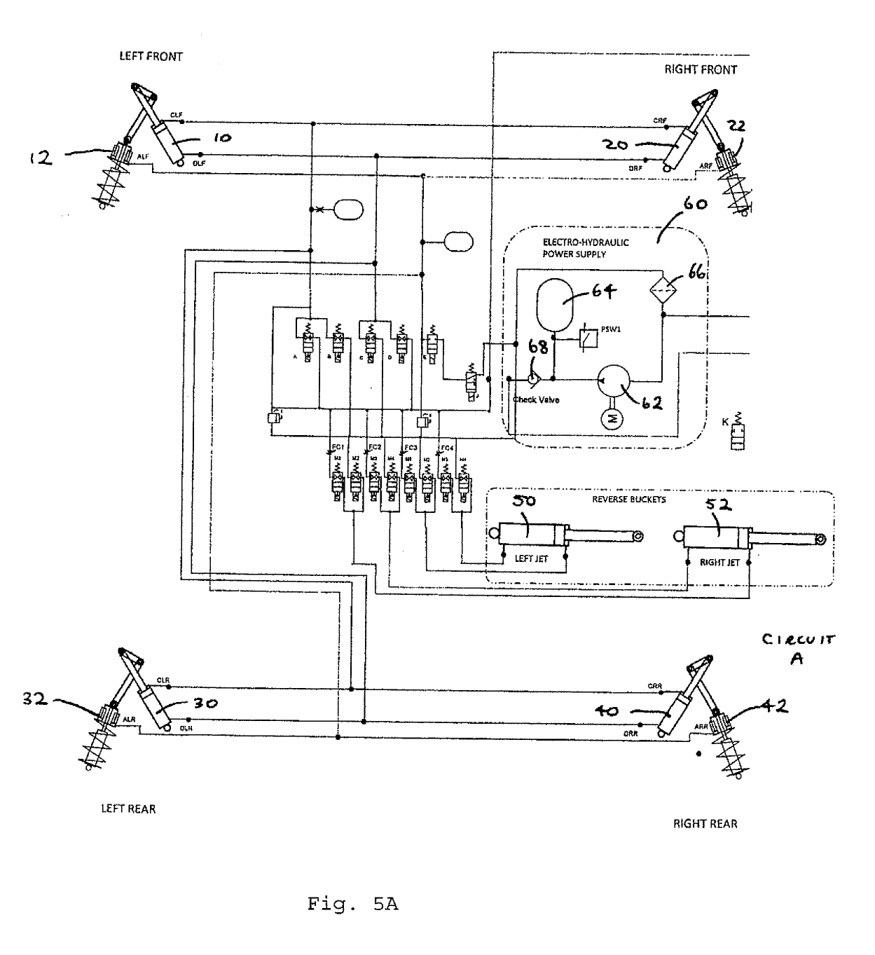

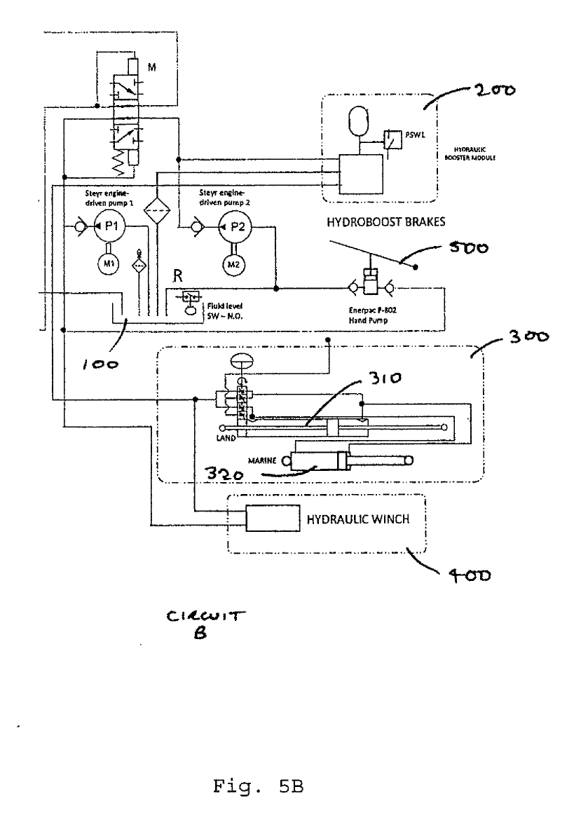

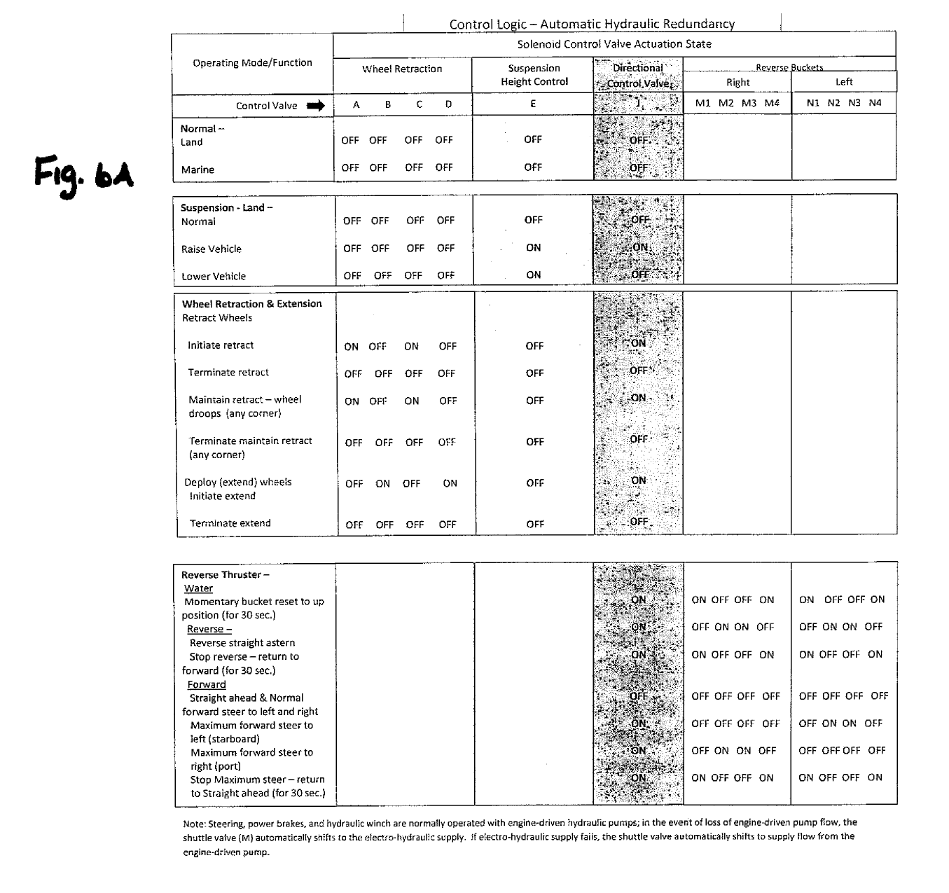

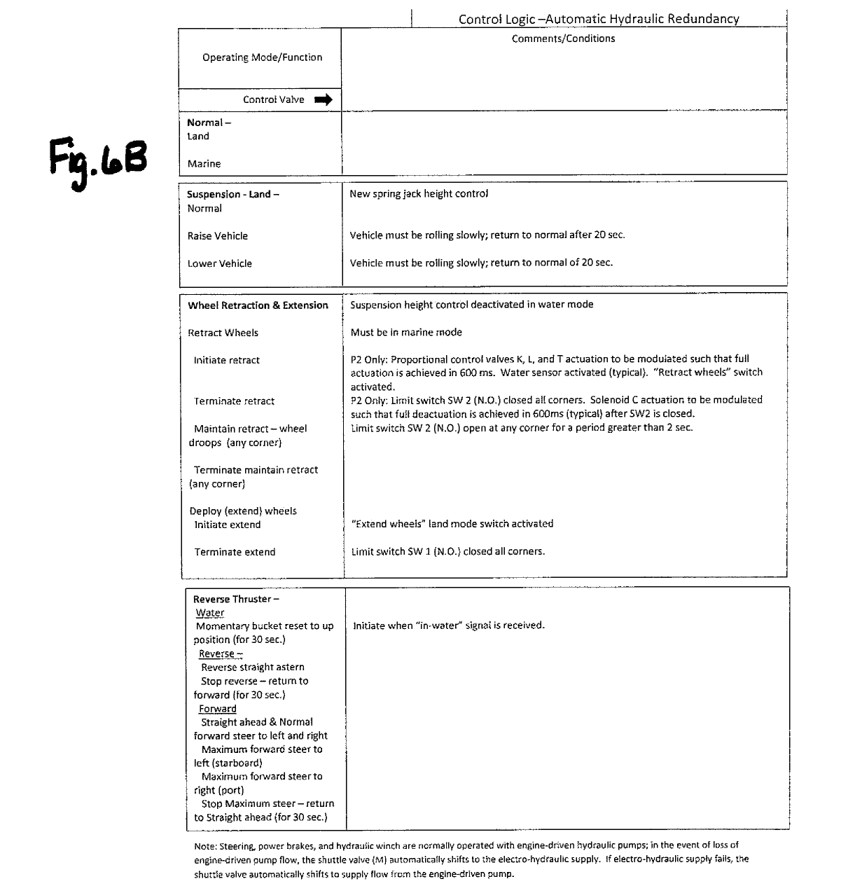

Referring next to FIG. 5, there is illustrated a schematic hydraulic system used in an amphibian according to a further preferred embodiment of the present invention. The corresponding schematic control logic diagram for the amphibian hydraulic system of FIG. 5 is shown in FIG. 6. The hydraulic system of FIGS. 5 and 6 is identical to that described above with reference to FIGS. 1 and 2, save for the addition of a shuttle valve M to provide for hydraulic redundancy in addition to the hand pump 500. In the event of failure of the conventional belt driven hydraulic pumps P1, P2, each driven by respective amphibian engines M1, M2, or of the electric motor driven hydraulic pump 62, the shuttle valve M automatically shifts to the supply provided by the respective other pump(s). Due to the difference in pump specification, some system compromise will be evident in certain failure modes, particularly in terms of the speed of retraction/protraction of each wheel or track drive in the event of failure of the electric motor driven hydraulic pump 62. Nevertheless, functionality will still be available.

It will be appreciated from the foregoing that the present invention provides an “on-demand” hydraulic power unit for hydraulic circuit A, and constant volume engine driven hydraulic pumps for hydraulic circuit B. The “on-demand” hydraulic power unit only runs when hydraulic pressure is required, extending pump and system component life cycle reducing heat generation requiring smaller capacity requirement and providing redundant/backup hydraulic power sources for powering the various components when required. This provides for highly optimised systems.

Whilst wheels have predominantly been referred to throughout for use as the land engaging and/or land propulsion means of the amphibian when operated on land, track drives or individual track drives (i.e. to replace a single wheel) may be used as an alternative or in combination with wheels.

Furthermore, it will be appreciated that drive (power) may be provided by internal combustion engines, electric motors, hydraulic motors, or hybrid engines in any suitable location (e.g. hydraulic wheel hub motors).

Although different embodiments according to the present invention have been described above, any one or more or all of the features described (and/or claimed in the appended claims) may be provided in isolation or in various combinations in any of the embodiments. As such, any one or more these features may be removed, substituted and/or added to any of the feature combinations described and/or claimed. For the avoidance of doubt, any of the features of any embodiment may be combined with any other feature from any of the embodiments.

Accordingly, whilst preferred embodiments of the present invention have been described above and illustrated in the drawings, these are by way of example only and non-limiting. It will be appreciated by those skilled in the art that many alternatives are possible within the ambit, spirit and scope of the invention, as set out in the appended claims.

1. A hydraulic system for an amphibian provided with at least one retractable wheel or track drive, the hydraulic system comprising:
a first hydraulic circuit comprising at least one hydraulic actuator and associated controller for retracting and protracting the at least one wheel or track drive; and
a second hydraulic control comprising at least one hydraulic actuator and associated controller for providing hydraulic assist for steering and/or braking functions of the amphibian.

2. A hydraulic system as claimed in claim 1 wherein the first hydraulic circuit is closed center.

3. A hydraulic system as claimed in claim 1 wherein the first hydraulic circuit comprises an on demand hydraulic power unit comprising an electric motor driven hydraulic pump.

4. A hydraulic system as claimed in claim 1 wherein the second hydraulic circuit is open center.

5. A hydraulic system as claimed in claim 1 wherein the second hydraulic circuit comprises a belt driven hydraulic pump.

6. A hydraulic system as claimed in claim 1 wherein the a first hydraulic circuit and associated controller additionally comprises at least one further hydraulic actuator to provide for spring jack operation to extend the ride height of the amphibian at each of the at least one wheel or track drive locations and/or to control a reverse bucket operation of a jet drive provided for marine propulsion of the amphibian in a water mode.

7. A hydraulic system as claimed in claim 1 wherein the a second hydraulic circuit and associated controller additionally comprises at least one further ancillary component requiring hydraulic assist.

8. A hydraulic system as claimed in claim 7 wherein the at least one further ancillary component requiring hydraulic assist is a winch.

9. A hydraulic system as claimed in claim 1 wherein the first and second hydraulic circuits can be linked by at least one control or shuttle valve to provide for redundancy in a case of hydraulic power failure in one or other of the first and second hydraulic circuits.

10. An amphibian comprising the hydraulic system as claimed in claim 1.

11. An amphibian as claimed in claim 10 wherein the amphibian comprises:
at least one prime mover; and
at least one retractable wheel or track drive.

12. An amphibian as claimed in claim 10 operable in land and marine modes wherein when the amphibian is operated in the marine mode, sufficient hydrodynamic lift is achieved for the amphibian to plane.

13. An amphibian as claimed in claim 10 operable in land and marine modes wherein when the amphibian is operated in the land mode it can be driven in one, two, three or four wheel or track drive.
